(19) United States
(12) Patent Application Publication
(10) Pub. No.: US 2025/0376964 A1
(43) Pub. Date: Dec. 11, 2025

(54) AUTOMATIC GAS-FUEL SWITCHING SYSTEM

(71) Applicant: CHONGQING AM PRIDE POWER & MACHINERY CO., LTD, CHONGQING (CN)

(72) Inventors: Anyuan XIE, CHONGQING (CN); Huiyang TANG, CHONGQING (CN); Jianguo BAI, CHONGQING (CN); Shangyong QIN, CHONGQING (CN)

(21) Appl. No.: 19/309,998

(22) Filed: Aug. 26, 2025

Related U.S. Application Data
(63) Continuation of application No. PCT/CN2024/095891, filed on May 29, 2024.

(30) Foreign Application Priority Data
May 6, 2024 (CN) 2024209544171.5

(51) Int. Cl. F02M 13/08

(52) U.S. Cl. CPC F02M 13/08

(57) ABSTRACT

An automatic gas-fuel switching system includes a gas source, a fuel source, a pressure reducing valve, and a carburetor, where the fuel source is connected to the carburetor through a fuel pipe, and a fuel passage is formed inside the carburetor; the gas source is connected to the pressure reducing valve through a first gas pipe, and the pressure reducing valve is connected to the carburetor through a second gas pipe; the carburetor is provided with a pneumatic lifting mechanism that includes a housing, the housing is provided with a gas inlet, and a pneumatic elastic member and an ejector pin connected to each other are disposed within the housing; and a branch pipe connected to the gas inlet is disposed on the first gas pipe. Compared to the prior art, in the present disclosure, switching between gas and fuel is achieved solely by operating the gas source.

### TECHNICAL FIELD

The present disclosure relates to the technical field of gasoline generators, and in particular to an automatic gas-fuel switching system.

### BACKGROUND

Gaseous fuels such as liquefied petroleum gas (LPG) and natural gas (NG) are more economical and environmentally friendly than gasoline, and more convenient to use. Therefore, incorporation of the gaseous fuel as an alternative energy carrier is considered for conventional small-scale gasoline generators. In the prior art, all dual-fuel generators employ manual or electric switching modes. Specifically, when gas is required, it is necessary to shut off fuel supply before initiating gas supply; and when fuel is required, it is necessary to shut off the gas supply before initiating the fuel supply. This fuel switching process is operationally complex, deficient in intelligence and convenience, and highly limited in applications.

### SUMMARY

An objective of the present disclosure is to provide an automatic gas-fuel switching system to overcome the drawbacks of dual-fuel generators in the prior art that the fuel switching process is operationally complex, and deficient in intelligence and convenience.

To solve the above objective, the present disclosure adopts the following technical solution:

An automatic gas-fuel switching system includes a gas source, a fuel source, a pressure reducing valve, and a carburetor, where the fuel source is connected to the carburetor through a fuel pipe, and a fuel passage is formed inside the carburetor; the gas source is connected to the pressure reducing valve through a first gas pipe, and the pressure reducing valve is connected to the carburetor through a second gas pipe; the carburetor is provided with a pneumatic lifting mechanism that includes a housing, the housing is provided with a gas inlet, a pneumatic elastic member and an ejector pin connected to each other are disposed within the housing, and the pneumatic elastic member, upon deformation, is configured to drive the ejector pin to ascend so as to block the fuel passage, and upon returning, is configured to drive the ejector pin to descend so as to unblock the fuel passage; and a branch pipe connected to the gas inlet is disposed on the first gas pipe.

For the present disclosure adopting the above technical solution, when gas is required, the gas source is opened, a certain pressure is formed within the first gas pipe and the branch pipe and introduced into the pneumatic lifting mechanism, and the pneumatic elastic member deforms to drive the ejector pin to ascend so as to block the fuel passage, thereby achieving automatic blockage of the fuel passage; and gas in the first gas pipe is depressurized through the pressure reducing valve and then delivered into the second gas pipe, a pressure (which is insufficient to induce formation of the pneumatic elastic member) within the second gas pipe meets the intake requirements of the engine, and the engine thus operates using gas. When fuel is required, the gas source is closed, the pressure within the first gas pipe and the branch pipe is insufficient, the pneumatic elastic member returns to drive the ejector pin to descend so as to unblock the fuel passage, thereby achieving automatic unblocking of the fuel passage; and the engine thus operates using fuel. Compared to the problems of the dual-fuel generators in the prior art that the fuel switching process is operationally complex, and deficient in intelligence and convenience, in the present disclosure, opening the gas source enables automatic blockage of the fuel passage, while closing the gas source enables automatic unblocking of the fuel passage; and switching between gas and fuel is achieved solely by operating the gas source, thereby enhancing the operational convenience.

Further, the carburetor includes a cup, and a bottom of the cup is provided with a through hole for fuel; the ejector pin is aligned concentrically with the through hole, and a front end of the ejector pin extends into the cup, and is configured to block or unblock the through hole when driven by the pneumatic elastic member.

Further, the pneumatic elastic member is a corrugated diaphragm assembly, a periphery of the corrugated diaphragm assembly is fixed to the housing, a pneumatic chamber is formed between one side of the corrugated diaphragm assembly and the housing, and the ejector pin is fixed to the other side of the corrugated diaphragm assembly; the branch pipe is in fluid communication with the pneumatic chamber through the gas inlet; and when gas is supplied, a certain pressure is formed in the branch pipe, and gas in the pneumatic chamber squeezes the corrugated diaphragm assembly to deform, thereby further driving the ejector pin to ascend to block the fuel passage.

Further, the corrugated diaphragm assembly includes a first corrugated diaphragm and a second corrugated diaphragm arranged in parallel, and bosses are formed centrally on adjacent sides of both diaphragms, thereby causing mutual abutment therebetween; the ejector pin is fixed to the other side of the first corrugated diaphragm; a diameter of the first corrugated diaphragm is smaller than a diameter of the second corrugated diaphragm; and with such configuration, the second corrugated diaphragm undergoes the same axial deformation magnitude as the first corrugated diaphragm, but the second corrugated diaphragm exhibits a higher deformation ratio relative to the own dimensions, with a greater elasticity for an improved rebound capability, thereby ensuring more stable operation of the pneumatic lifting mechanism.

Further, the housing includes a base, an intermediate bracket, and a top cover sequentially connected, and the base is fixed to the cup; a periphery of the first corrugated diaphragm is sandwiched between the base and the intermediate bracket, and a periphery of the second corrugated diaphragm is sandwiched between the intermediate bracket and the top cover; and such housing configuration facilitates easier fixation of both the first corrugated diaphragm and the second corrugated diaphragm.

Further, a side wall of the intermediate bracket is provided with a vent hole. When the first corrugated diaphragm and the second corrugated diaphragm deform, a volume of a space formed among the first corrugated diaphragm, the second corrugated diaphragm and the intermediate bracket varies. To prevent internal pressure variations within the space from adversely affecting operation of the corrugated diaphragm assembly, the vent hole is configured to permit ingress or egress of ambient air, thereby maintaining the pressure stable.

Further, the pneumatic elastic member is a bellows having an open end and a closed end; and the open end of the bellows is fixed to the housing, the branch pipe is in fluid communication with an internal cavity of the bellows through the gas inlet, and the ejector pin is fixed to the closed end of the bellows. When gas is supplied, a certain pressure is formed in the branch pipe, gas in the internal cavity of the bellows squeezes the bellows assembly to deform, and the bellows extends, thereby further driving the ejector pin to ascend to block the fuel passage.

Further, another pressure reducing valve is disposed between a gas outlet of the gas source and the first gas pipe.

Compared with the prior art, the present disclosure has the following beneficial effects: opening the gas source enables automatic blockage of the fuel passage, while closing the gas source enables automatic unblocking of the fuel source; and switching between gas and fuel is achieved solely by operating the gas source, thereby enhancing the operational convenience.

### BRIEF DESCRIPTION OF THE DRAWINGS

FIG. 1 is a structural view of the present disclosure.

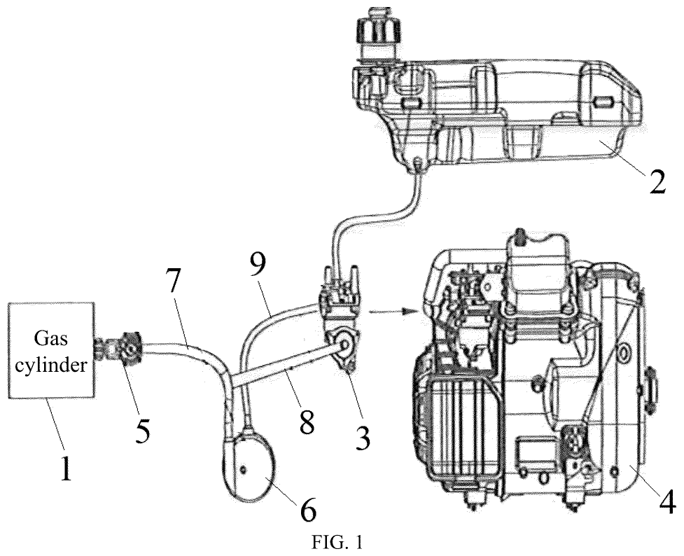

FIG. 2 is a structural view of a carburetor.

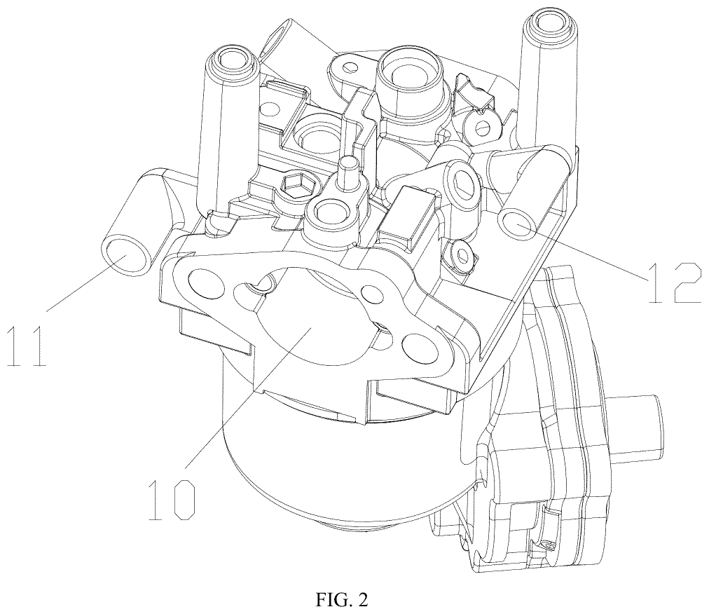

FIG. 3 is an exploded view of the carburetor.

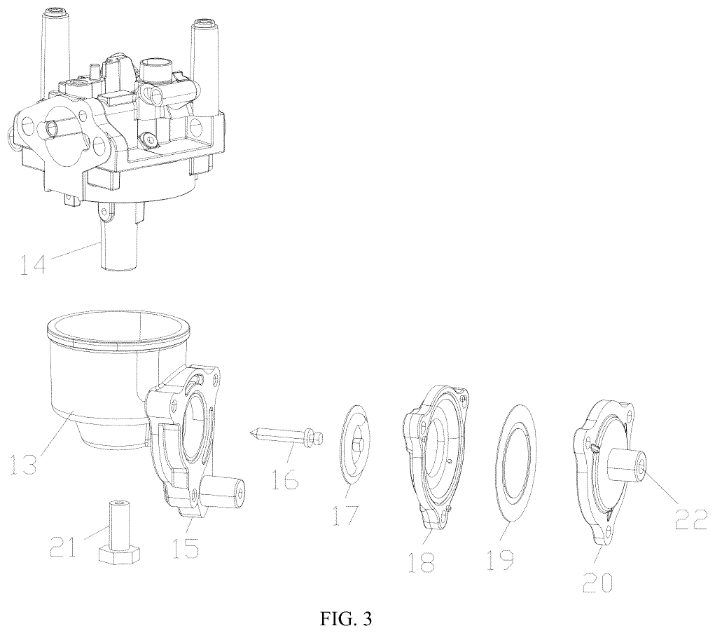

FIG. 4 is a partial sectional view of the carburetor.

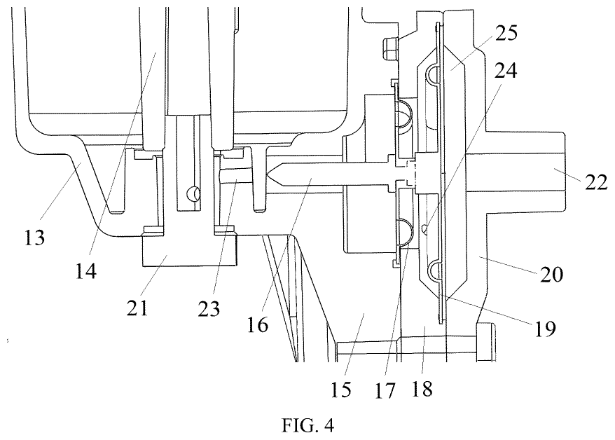

Reference numerals in the figures: 1—gas source; 2—fuel source; 3—carburetor; 4—engine; 5—primary pressure reducing valve; 6—secondary pressure reducing valve; 7—first gas pipe; 8—branch pipe; 9—second gas pipe; 10—air inlet; 11—fuel port; 12—gas port; 13—cup; 14—main nozzle; 15—base; 16—ejector pin; 17—first corrugated diaphragm; 18—intermediate bracket; 19—second corrugated diaphragm; 20—top cover; 21—fastening bolt; 22—gas inlet; 23—through hole; 24—vent hole; and 25—pneumatic chamber.

### DETAILED DESCRIPTIONS OF THE EMBODIMENTS

The present disclosure will be further illustrated below in conjunction with the accompanying drawings.

To make the objectives, technical solutions and advantages of the present disclosure more clearly, the present disclosure will be described further below in detail in combination with the drawings and embodiments. It should be understood that the specific embodiments described herein are used only for explaining the present disclosure, rather than limiting the present disclosure.

An automatic gas-fuel switching system includes a gas source 1, a fuel source 2, a pressure reducing valve, and a carburetor 3, where the fuel source 2 is connected to the carburetor 3 through a fuel pipe, and a fuel passage is formed inside the carburetor 3; the gas source 1 is connected to the pressure reducing valve through a first gas pipe 7, and the pressure reducing valve is connected to the carburetor 3 through a second gas pipe 9; the carburetor 3 is provided with a pneumatic lifting mechanism that includes a housing, the housing is provided with a gas inlet 22, a pneumatic elastic member and an ejector pin 16 connected to each other are disposed within the housing, and the pneumatic elastic member, upon deformation, is configured to drive the ejector pin 16 to ascend so as to block the fuel passage, and upon returning, is configured to drive the ejector pin 16 to descend to as to unblock the fuel passage; and a branch pipe 8 connected to the gas inlet 22 is disposed on the first gas pipe 7. The gas source 1 is a gas cylinder, and the fuel source 2 is a fuel tank; an air inlet 10 in the carburetor 3 is in fluid communication with a combustion chamber of an engine 4, and a negative pressure is generated within the air inlet 10 during operation of the engine 4 to suck gas or fuel into the combustion chamber; and operation of the engine 4 drives a generator to generate electricity.

The carburetor 3 includes a cup 13, and a bottom of the cup 13 is provided with a through hole 23 for fuel; the ejector pin 16 is aligned concentrically with the through hole 23, and a front end of the ejector pin 16 extends into the cup 13, and is configured to block or unblock the through hole 23 when driven by the pneumatic elastic member.

It should be noted that compared to carburetors in the prior art, the carburetor 3 is identical in structure except for incorporation of the pneumatic lifting mechanism on the cup. A prior art structure is as follows: the carburetor 3 is provided with a fuel port 11 and a gas port 12, and the gas port 12 is in fluid communication with the air inlet 10; the fuel port 11 is in fluid communication with an internal cavity of the cup 13, an inner bottom of the cup 13 is provided with an annular boss, and the through hole 23 is disposed in the annular boss; a fastening bolt 21 is disposed in a center of the annular boss, the fastening bolt 21 has a hollow shank portion with a through hole for fuel formed in a wall surface, a main nozzle 14 is centrally disposed within the cavity of the cup 13, a fuel passage is a passage where fuel flows into a center hole of the main nozzle 14 from the internal cavity of the cup 13, and the fuel passage is blocked by blocking the through hole 23.

The pneumatic elastic member is a corrugated diaphragm assembly, a periphery of the corrugated diaphragm assembly is fixed to the housing, a pneumatic chamber 25 is formed between one side of the corrugated diaphragm assembly and the housing, and the ejector pin 16 is fixed to the other side of the corrugated diaphragm assembly; and the branch pipe 8 is in fluid communication with the pneumatic chamber 25 through the gas inlet 22.

The corrugated diaphragm assembly includes a first corrugated diaphragm 17 and a second corrugated diaphragm 19 arranged in parallel, and bosses are formed centrally on adjacent sides of both diaphragms, thereby causing mutual abutment therebetween; the ejector pin 16 is fixed to the other side of the first corrugated diaphragm 17; and a diameter of the first corrugated diaphragm 17 is smaller than a diameter of the second corrugated diaphragm 19.

The housing includes a base 15, an intermediate bracket 18, and a top cover 20 sequentially connected, and the base 15 is fixed to the cup 13; and a periphery of the first corrugated diaphragm 17 is sandwiched between the base 15 and the intermediate bracket 18, and a periphery of the second corrugated diaphragm 19 is sandwiched between the intermediate bracket 18 and the top cover 20.

A side wall of the intermediate bracket 18 is provided with a vent hole 24.

The pneumatic elastic member may be further configured as follows: the pneumatic elastic member is a bellows having an open end and a closed end; and the open end of the bellows is fixed to the housing, the branch pipe 8 is in fluid communication with an internal cavity of the bellows through the gas inlet 22, and the ejector pin 16 is fixed to the closed end of the bellows.

Another pressure reducing valve is disposed between a gas outlet of the gas source 1 and the first gas pipe 7; this pressure reducing valve serves as a primary pressure reducing valve 5, and the pressure reducing valve between the first gas pipe 7 and the second gas pipe 9 serves as a secondary pressure reducing valve 6; and because the gas cylinder has a great pressure, two-stage pressure reducing valves are arranged for pressure reduction, so as to ensure that the pressure within the second gas pipe 9 meets the intake requirements of the engine 4.

With the present disclosure adopting the above technical solution, when gas is required, the gas source 1 is opened, a certain pressure is formed within the first gas pipe 7 and the branch pipe 8 and introduced into the pneumatic lifting mechanism, and the pneumatic elastic member deforms to drive the ejector pin 16 to ascend so as to block the fuel passage, thereby achieving automatic blockage of the fuel passage; and the engine 4 thus operates using gas. When fuel is required, the gas source 1 is closed, the pressure within the first gas pipe 7 and the branch pipe 8 is insufficient, and the pneumatic elastic member returns to drive the ejector pin 16 to descend so as to unblock the fuel passage, thereby achieving automatic unblocking of the fuel passage; and the engine 4 thus operates using fuel. Compared to the problems of the dual-fuel generators in the prior art that the fuel switching process is operationally complex, and deficient in intelligence and convenience, in the present disclosure, opening the gas source enables automatic blockage of the fuel passage, while closing the gas source enables automatic unblocking of the fuel passage; and switching between gas and fuel is achieved solely by operating the gas source, thereby enhancing the operational convenience.

The above contents are only preferred embodiments of the present disclosure, rather than limiting the present disclosure; and any modification, equivalent alternation or improvement within the spirit and principle of the present disclosure should fall within the protection scope of the present disclosure.

What is claimed is:

1. An automatic gas-fuel switching system, comprising a gas source, a fuel source, a pressure reducing valve, and a carburetor, wherein the fuel source is connected to the carburetor through a fuel pipe, and a fuel passage is formed inside the carburetor; the gas source is connected to the pressure reducing valve through a first gas pipe, and the pressure reducing valve is connected to the carburetor through a second gas pipe; the carburetor is provided with a pneumatic lifting mechanism which comprises a housing, the housing is provided with a gas inlet, a pneumatic elastic member and an ejector pin connected to each other are disposed within the housing, and the pneumatic elastic member, upon deformation, is configured to drive the ejector pin to ascend so as to block the fuel passage, and upon returning, is configured to drive the ejector pin to descend so as to unblock the fuel passage; and a branch pipe connected to the gas inlet is disposed on the first gas pipe.

2. The automatic gas-fuel switching system according to claim 1, wherein the carburetor comprises a cup, and a bottom of the cup is provided with a through hole for fuel; the ejector pin is aligned concentrically with the through hole, and a front end of the ejector pin extends into the cup, and is configured to block or unblock the through hole when driven by the pneumatic elastic member.

3. The automatic gas-fuel switching system according to claim 2, wherein the pneumatic elastic member is a corrugated diaphragm assembly, a periphery of the corrugated diaphragm assembly is fixed to the housing, a pneumatic chamber is formed between one side of the corrugated diaphragm assembly and the housing, and the ejector pin is fixed to the other side of the corrugated diaphragm assembly; the branch pipe is in fluid communication with the pneumatic chamber through the gas inlet.

4. The automatic gas-fuel switching system according to claim 3, wherein the corrugated diaphragm assembly comprises a first corrugated diaphragm and a second corrugated diaphragm arranged in parallel, and bosses are formed centrally on adjacent sides of both diaphragms, thereby causing mutual abutment therebetween; the ejector pin is fixed to the other side of the first corrugated diaphragm; and a diameter of the first corrugated diaphragm is smaller than a diameter of the second corrugated diaphragm.

5. The automatic gas-fuel switching system according to claim 4, wherein the housing comprises a base, an intermediate bracket, and a top cover sequentially connected, and the base is fixed to the cup; and a periphery of the first corrugated diaphragm is sandwiched between the base and the intermediate bracket, and a periphery of the second corrugated diaphragm is sandwiched between the intermediate bracket and the top cover.

6. The automatic gas-fuel switching system according to claim 5, wherein a side wall of the intermediate bracket is provided with a vent hole.

7. The automatic gas-fuel switching system according to claim 1, wherein the pneumatic elastic member is a bellows having an open end and a closed end; and the open end of the bellows is fixed to the housing, the branch pipe is in fluid communication with an internal cavity of the bellows through the gas inlet, and the ejector pin is fixed to the closed end of the bellows.

8. The automatic gas-fuel switching system according to claim 1, wherein another pressure reducing valve is disposed between a gas outlet of the gas source and the first gas pipe.
